(19) United States
(12) Patent Application Publication
(10) Pub. No.: US 2013/0303664 A1
(43) Pub. Date: Nov. 14, 2013

(54) WOOD/POLYMER COMPOSITE WITH IMPROVED THERMAL STABILITY

(71) Applicants: Frédéric Malet, Rouen (FR); Nour-Eddine La Bounia, Orthex (FR); Fabien Sliwa, Pau (FR); Gérard Marin, Assat (FR); Fatima Charrier, Saint Pierre Du Mont (FR)

(72) Inventors: Frédéric Malet, Rouen (FR); Nour-Eddine La Bounia, Orthex (FR); Fabien Sliwa, Pau (FR); Gérard Marin, Assat (FR); Fatima Charrier, Saint Pierre Du Mont (FR)

(73) Assignees: ARKEMA FRANCE, Colombes (FR); UNIVERSITE DE PAU ET DES PAYS DE L'ADOUR, Pau Universite Cedex (FR); CNRS, Paris Cedex 16 (FR)

(21) Appl. No.: 13/976,350

(22) PCT Filed: Dec. 23, 2011
(86) PCT No.: PCT/FR2011/053185

§ 371 Date: Jul. 29, 2013

(30) Foreign Application Priority Data
Dec. 27, 2010 (FR) 1061268

(51) Int. Cl. C08L 97/02

(52) U.S. Cl. CPC C08L 97/02
USPC 524/14

(57) ABSTRACT

A composite including a thermoplastic elastomer and a plant flour. This composite has an increased thermal stability and can be used in a construction material.

### TECHNICAL FIELD

The technical field to which the invention relates is that of composite materials based on polymers and on a reinforcement derived from bioresources. These materials may, for example, be used as construction materials.

### PRIOR ART

It is known to manufacture composite materials by mixing wood fibers also referred to as “wood flour” with polymers such as polyolefins or polyvinyl chloride. Such a composite is known as a wood-polymer composite (WPC). The most widely used polyolefins are polyethylene (PE) and polypropylene (PP). This type of composite is used as a construction material and is seeing its field of application expand to, for example, furniture and motor vehicles, in particular passenger compartments.

One of the problems encountered in the manufacture of such a composite is that of the incompatibility between the polymer and the wood fibers. Indeed, polyolefins have hydrophobic properties whereas wood fibers are hydrophilic. In order to improve the compatibility between the polymer and the wood fibers, use is generally made of a coupling agent, or a pretreatment of the polymer and/or of the plant fiber is carried out in order to improve their compatibility. A polymer is sought that has functional groups capable of interacting with the functional groups of the wood fibers. It would thus be possible to prepare a wood-polymer composite material that does not comprise a coupling agent.

Moreover, a wood-polymer composite generally has a low resistance to thermal degradation due to the presence of the wood fibers which do not withstand a high temperature. Indeed, the wood fibers begin to decompose when they are subjected to a temperature above approximately 200° C. A wood-polymer composite is therefore sought that has an increased thermal stability, that is to say the decomposition of which occurs only above around 275° C., preferably at least 300° C.

A wood-polymer composite is also sought in which the polymer used has a melting point of less than 200° C. so that it may be sufficiently malleable in order to be able to be used in the extrusion devices employed in the manufacture of the composite.

Finally, a wood-polymer composite is preferably sought that contains substances solely derived from renewable raw materials.

### SUMMARY OF THE INVENTION

For this purpose, the invention proposes a composite comprising a thermoplastic elastomer and a plant flour.

According to one embodiment, the plant flour originates from a plant chosen from the group comprising maritime pine, spruce wood, beech wood and corn cob.

According to one embodiment, the thermoplastic elastomer is chosen from the group comprising copolyether-block-amides, copolyether-block-urethanes and copolyether-block-esters, preferably copolyether-block-amides and copolyether-block-esters, preferably copolyether-block amides.

According to one embodiment, the thermoplastic elastomer is a copolyether-block-amide comprising from 20% to 60% by weight of polyamide and from 40% to 80% by weight of polyether, preferably from 25% to 55% by weight of polyamide and 45% to 75% by weight of polyether.

According to one embodiment, the copolyether-block amide comprises a soft polytetramethylene ether glycol block.

According to one embodiment, the polyamide is polyamide 11.

According to one embodiment, the plant flour represents less than 10% of the weight of the composite.

According to one embodiment, the plant flour represents from 10% to 80%, preferably 20% to 50%, more preferably 20% to 40% of the weight of the composite.

According to one embodiment, the composite contains less than 5%, preferably less than 1% of coupling agent.

Another subject of the invention is a granule comprising the composite according to the invention and also a construction material, a shoe, a piece of furniture, and also a passenger compartment comprising this granule or this composite.

A final subject of the invention is a process for manufacturing the composite according to the invention, comprising the steps of:
a) introducing the thermoplastic elastomer and the plant flour into an extruder,
b) extruding the mixture in the form of granules or profile.

According to one embodiment, the process comprises, before step a), a step of preparing a mixture of the thermoplastic elastomer with the plant flour.

According to one embodiment, the process comprises, before step a), a step of drying the thermoplastic elastomer and the plant flour.

According to one embodiment, the process comprises, after step b), a step of drying the composite followed by a step of compression in order to form a granule or a profile.

### BRIEF DESCRIPTION OF THE FIGURES

FIG. 1 represents the curves obtained by thermogravimetric analysis under nitrogen of the following test samples:

PEBA 1 alone,

WF1 alone,

PEBA 1/WF1 composite for various percentages of WF1.

FIG. 2 represents the curves obtained by thermogravimetric analysis in air of the following test samples:

PEBA 1 alone,

WF1 alone,

PEBA 1/WF1 composite for various percentages of WF1.

FIG. 3 represents the variation of the temperature corresponding to a reduction of 10% and 50% of the weight of the sample, T_{0.1} and T_{0.5} respectively, for various percentages of wood flour.

FIG. 4 represents the variation of the percentage of degradation residue as a function of the percentage of wood flour at degradation temperatures of 400° C. and 500° C.

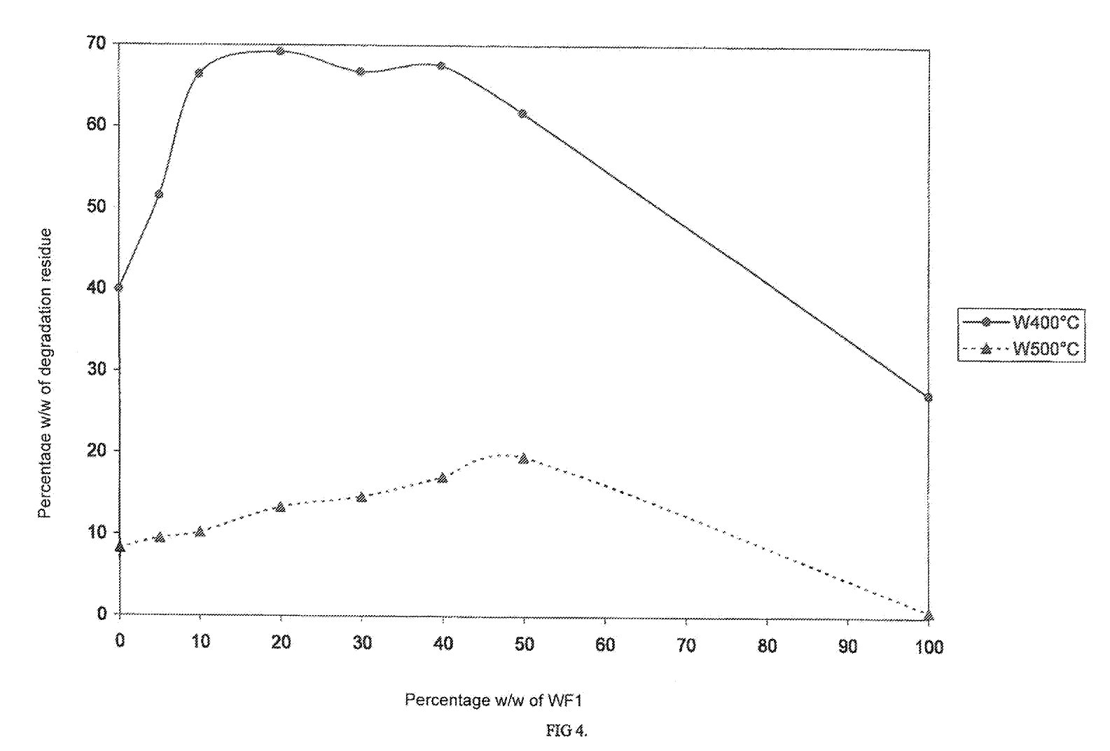

FIG. 5 represents the curves obtained by thermogravimetric analysis in air of the following test samples:

PEBA 1 alone,

WF2 alone,

PEBA 1/WF2 composite for various percentages of WF2.

FIG. 6 represents the curves obtained by thermogravimetric analysis in air of the following test samples:

PEBA 2 alone,

WF1 alone,

PEBA 2/WF1 composite for various percentages of WF1.

FIG. 7 represents the curves obtained by thermogravimetric analysis in air of the following test samples:

polyamide 11 (PA11),

WF1,

PA 11/WF1 composite for various percentages of WF1.

FIG. 8 represents the curves obtained by thermogravimetric analysis in air of the following test samples:

polytetramethylene ether glycol (PTMG),

WF1,

PTMG/WF1 composite for various percentages of WF1.

FIG. 9 represents, for a constant degradation temperature of 220° C., the variation of the weight as a function of the time of the following test samples:

PEBA 1

WF1

PEBA 1/WF1 composite for various percentages of WF1.

FIG. 10 represents the variation of the weight as a function of the weight percentage of wood flour for a degradation temperature of 220° C. and an exposure time of 600 min.

FIG. 11 represents, for a constant degradation temperature of 300° C., the variation of the weight as a function of the time of the following test samples:

PEBA 1

WF1

PEBA 1/WF1 composite for various percentages of WF1.

### DETAILED DESCRIPTION OF THE EMBODIMENTS OF THE INVENTION

The invention is based on the discovery that, due to its hydrophilic properties, a thermoplastic elastomer polymer interacts with the plant flour which itself has hydrophilic properties. When a composite comprising a thermoplastic elastomer polymer and a plant flour is exposed to a temperature that leads to the start of degradation of the composite, it forms a layer of a combustion product which acts as a barrier and which makes it possible to slow down this degradation.

The term “composite” is understood to mean an assembly of at least two materials that are immiscible but that have a high adhesive strength.

The expression “plant flour” is understood to mean a powder of a plant material, the particle size of which lies within the range extending from 0.5 μm to 2000 μm, preferably from 5 to 1200 μm, more preferably from 30 to 500 μm. The plant may be a wood such as maritime pine, spruce wood, beech wood, birch wood, or be derived from a plant, such as a corn cob. The plant flour is produced by grinding then screening.

The expression “elastomer polymer” denotes a polymer having elastic properties, generally characterized by a low Young's modulus and a high yield strain.

The expression “thermoplastic polymer” denotes a polymer which softens by heating above a certain temperature and which below this temperature becomes hard again. Such a polymer can thus be molded.

A thermoplastic elastomer material (TPE) is a multiphase material having at least two transition temperatures, the first temperature T1, which is in general the glass transition temperature, and the second temperature T2, above T1. In general, T2 is the melting point of the material. At a temperature below T1, the material is rigid. Between T1 and T2, elastic behavior of the material can be observed, and above T2, the material is molten. These materials therefore combine the elastic behavior of rubber with the processability of thermoplastics.

The thermoplastic elastomer may be chosen from the group comprising copolyether-block-amides, copolyether-block-urethanes, copolyether-block-esters, copolymers of styrene-butadiene-styrene (SBS), copolymers of styrene-ethylene-butadiene-styrene (SEBS), preferably copolyether-block-amides. Mention may also be made of the mixture of a thermoplastic polymer and of an elastomer, whether vulcanized or not, and rubbers such as natural rubber.

Copolyether-block-amides or copolymers comprising polyether blocks and polyamide blocks, abbreviated to “PEBA”, result from the polycondensation of polyamide blocks comprising reactive ends with polyether blocks comprising reactive ends, such as, inter alia:

1) polyamide blocks comprising diamine chain ends with polyoxyalkylene blocks comprising dicarboxyl chain ends;

2) polyamide blocks comprising dicarboxyl chain ends with polyoxyalkylene blocks comprising diamine chain ends, which are obtained by cyanoethylation and hydrogenation of aliphatic α,ω-dihydroxylated polyoxyalkylene blocks, known as polyetherdiols;

3) polyamide blocks comprising dicarboxyl chain ends with polyetherdiols, the products obtained being, in this specific case, polyetheresteramides.

The polyamide blocks comprising dicarboxyl chain ends originate, for example, from the condensation of precursors of polyamides in the presence of a chain-limiting dicarboxylic acid. The polyamide blocks comprising diamine chain ends originate, for example, from the condensation of precursors of polyamides in the presence of a chain-limiting diamine.

The number-average molar mass Mn of the polyamide blocks is between 400 and 20 000 g/mol and preferably between 500 and 10 000 g/mol.

The polymers comprising polyamide blocks and polyether blocks can also comprise randomly distributed units.

Use may be advantageously made of three types of polyamide blocks.

According to a first type, the polyamide blocks originate from the condensation of a dicarboxylic acid, in particular those having from 4 to 20 carbon atoms, preferably those having from 6 to 18 carbon atoms, and of an aliphatic or aromatic diamine, in particular those having from 2 to 20 carbon atoms, preferably those having from 6 to 14 carbon atoms.

Mention may be made, as examples of dicarboxylic acids, of 1,4-cyclohexyldicarboxylic acid, butanedioc, adipic, azelaic, suberic, sebacic, dodecanedicarboxylic and octadecanedicarboxylic acids and terephthalic and isophthalic acids, but also dimerized fatty acids.

Mention may be made, as examples of diamines, of tetramethylenediamine, hex amethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM), and 2,2-bis(3-methyl-4-aminocyclohexyl)propane (BMACP), and para-amino-dicyclohexylmethane (PACM), and is ophoronediamine (IPDA), 2,6-bis(aminomethyl)norbornane (BAMN) and piperazine (Pip).

The following blocks advantageously exist: PA-4,12, PA-4,14, PA-4,18, PA-6,10, PA-6,12, PA-6,14, PA-6,18, PA-9,12, PA-10,10, PA-10,12, PA-10,14 and PA-10,18, the first figure indicating the number of carbon atoms of the diamine and the second figure indicating the number of carbon atoms of the carboxylic acid.

According to a second type, the polyamide blocks result from the condensation of one or more α,ω-aminocarboxylic acids and/or of one or more lactams having from 6 to 12 carbon atoms in the presence of a dicarboxylic acid having from 4 to 12 carbon atoms or of a diamine. Mention may be made, as examples of lactams, of caprolactam, oenantholactam and lauryllactam. Mention may be made, as examples of α,ω-aminocarboxylic acid, of aminocaproic, 7-aminoheptanoic, 11-aminoundecanoic and 12-aminododecanoic acids.

Advantageously, the polyamide blocks of the second type are of polyamide 11, of polyamide 12 or of polyamide 6.

According to a third type, the polyamide blocks result from the condensation of at least one α,ω-aminocarboxylic acid (or one lactam), at least one diamine and at least one dicarboxylic acid.

In this case, the polyamide PA blocks are prepared by polycondensation:
of the linear aliphatic or aromatic diamine or diamines having X carbon atoms;
of the dicarboxylic acid or acids having Y carbon atoms; and
of the comonomer or comonomers {Z} chosen from the lactams and the α,ω-aminocarboxylic acids having Z carbon atoms and the equimolar mixtures of at least one diamine having X1 carbon atoms and of at least one dicarboxylic acid having Y1 carbon atoms, (X1, Y1) being different from (X, Y),
said comonomer or comonomers {Z} being introduced in a proportion by weight ranging up to 50%, preferably up to 20% and more advantageously still up to 10%, with respect to the combined polyamide precursor monomers;
in the presence of a chain-limiting agent chosen from dicarboxylic acids.

Use is advantageously made, as chain-limiting agent, of the dicarboxylic acid having Y carbon atoms, which is introduced in excess with respect to the stoichiometry of the diamine or diamines.

According to an alternative form of this third type, the polyamide blocks result from the condensation of at least two α,ω-aminocarboxylic acids or of at least two lactams having from 6 to 12 carbon atoms or of a lactam and of an aminocarboxylic acid not having the same number of carbon atoms, in the optional presence of a chain-limiting agent. Mention may be made, as examples of aliphatic α,ω-aminocarboxylic acid, of aminocaproic, 7-aminoheptanoic, 11-aminoundecanoic and 12-aminododecanoic acids. Mention may be made, as examples of a lactam, of caprolactam, oenantholactam and lauryllactam. Mention may be made, as examples of aliphatic diamines, of hexamethylenediamine, dodecamethylenediamine and trimethylhexamethylenediamine. Mention may be made, as an example of cycloaliphatic diacids, of 1,4-cyclohexyldicarboxylic acid. Mention may be made, as examples of aliphatic diacids, of butanedioic, adipic, azelaic, suberic, sebacic and dodecanedicarboxylic acids, dimerized fatty acids (these dimerized fatty acids preferably have a dimer content of at least 98%; preferably, they are hydrogenated; they are sold under the Pripol® trade name by Uniqema or under the Empol® trade name by Henkel) and polyoxyalkylene-α,ω-diacids. Mention may be made, as examples of aromatic diacids, of terephthalic (T) and isophthalic (I) acids. Mention may be made, as examples of cycloaliphatic diamines, of the isomers of bis(4-aminocyclohexyl)methane (BACM), bis(3-methyl-4-aminocyclohexyl)methane (BMACM), and 2,2-bis(3-methyl-4-aminocyclohexyl)propane (BMACP), and para-aminodicyclohexylmethane (PACM). The other diamines commonly used can be isophoronediamine (IPDA), 2,6-bis(aminomethyl)norbornane (BAMN) and piperazine.

Mention may be made, as examples of polyamide blocks of the third type, of the following:
6,6/6 in which 6,6 denotes hexamethylenediamine units condensed with adipic acid and 6 denotes units resulting from the condensation of caprolactam.
6,6/6, 10/11/12 in which 6,6denotes hexamethylenediamine condensed with adipic acid, 6,10 denotes hexamethylenediamine condensed with sebacic acid, 11 denotes units resulting from the condensation of aminoundecanoic acid and 12 denotes units resulting from the condensation of lauryllactam.

The polyether blocks may represent from 5% to 85% by weight of the copolymer comprising polyamide and polyether blocks. The mass Mn of the polyether blocks is between 100 and 6000 g/mol and preferably between 200 and 3000 g/mol.

The polyether blocks consist of alkylene oxide units. These units can, for example, be ethylene oxide units, propylene oxide units or tetrahydrofuran units (which result in the polytetramethylene glycol sequences). Use is thus made of PEG (polyethylene glycol) blocks, that is to say those consisting of ethylene oxide units, PPG (polypropylene glycol) blocks, that is to say those consisting of propylene oxide units, PO3G (polytrimethylene glycol) blocks, that is to say those consisting of polytrimethylene ether glycol units (such copolymers with polytrimethylene ether blocks are described in the document U.S. Pat. No. 6,590,065), and PTMG blocks, that is to say those consisting of tetramethylene glycol units, also known as polytetrahydrofuran blocks. The PEBA® copolymers can comprise several types of polyethers in their chain, it being possible for the copolyethers to be block or random copolyethers.

Use may also be made of the blocks obtained by oxyethylation of bisphenols, such as for example bisphenol A. The latter products are described in patent EP 613 919.

The polyether blocks can also consist of ethoxylated primary amines. Mention may be made, as examples of ethoxylated primary amines, of the products of formula:

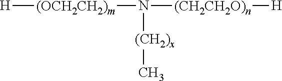

in which m and n are between 1 and 20 and x is between 8 and 18. These products are commercially available under the Noramox® trade name from CECA and under the Genamin® trade name from Clariant.

The soft polyether blocks can comprise polyoxyalkylene blocks comprising NH₂ chain ends, it being possible for such blocks to be obtained by cyanoacetylation of aliphatic α,ω-dihydroxylated polyoxyalkylene blocks, known as polyetherdiols. More particularly, use may be made of Jeffamines (for example, Jeffamine® D400, D2000, ED 2003 or XTJ 542, commercial products from Huntsman, also described in the documents of patents JP 2004346274, JP 2004352794 and EP 1 482 011).

The polyetherdiol blocks are either used as is and copolycondensed with polyamide blocks comprising carboxyl ends or they are aminated in order to be converted into polyetherdiamines and condensed with polyamide blocks comprising carboxyl ends. The general method for the two-stage preparation of PEBA® copolymers having ester bonds between the PA blocks and the PE blocks is known and is described, for example, in French patent FR 2 846 332. The general method for the preparation of the PEBA® copolymers of the invention having amide bonds between the PA blocks and the PE blocks is known and described, for example, in European patent EP 1 482 011. Polyether blocks may also be mixed with polyamide precursors and a chain-limiting diacid in order to prepare polymers comprising polyamide blocks and polyether blocks having randomly distributed units (one-stage process).

Of course, the designation PEBA in the present description of the invention relates equally well to the PEBAX® products sold by Arkema, to the Vestamid® products sold by Evonik®, to the Grilamid® products sold by EMS, to the Kellaflex® products sold by DSM or to any other PEBA from other suppliers.

Advantageously, the PEBA copolymers have PA blocks of PA-6, of PA-11, of PA-12, of PA-6,12, of PA-6,6/6, of PA-10,10 and/or of PA-6,14, preferably PA-11 and/or PA-12 blocks; and PE blocks of PTMG, of PPG and/or of PO₃G. The PEBAs based on PE blocks consisting predominantly of PEG are to be ranked in the range of the hydrophilic PEBAs. The PEBAs based on PE blocks consisting predominantly of PTMG are to be ranked in the range of the hydrophobic PEBAs.

Advantageously, said PEBA used in the composition according to the invention is obtained, at least partially, from biobased raw materials. Raw materials of renewable origin or biobased raw materials are understood to mean substances that comprise biobased carbon or carbon of renewable origin. Specifically, unlike the substances resulting from fossil materials, the substances composed of renewable raw materials comprise ¹⁴C. The “content of carbon of renewable origin” or “content of biobased carbon” is determined by application of Standards ASTM D 6866 (ASTM D 6866-06) and ASTM D 7026 (ASTM D 7026-04). By way of example, the PEBAs based on polyamide 11 originate at least in part from biobased raw materials and have a content of biobased carbon of at least 1%, which corresponds to a ¹²C/¹⁴C isotopic ratio of at least 1.2×10⁻¹⁴. Preferably, the PEBAs according to the invention comprise at least 50% by weight of biobased carbon with respect to the total weight of carbon, which corresponds to a ¹²C/¹⁴C isotopic ratio of at least 0.6×10⁻¹². This content is advantageously higher, in particular up to 100%, which corresponds to a ¹²C/¹⁴C isotopic ratio of 1.2×10⁻¹², in the case of PEBAs comprising PA-11 blocks and PE blocks comprising PO3G, PTMG and/or PPG resulting from raw materials of renewable origin.

The copolyether-block-amide may comprise from 5% to 85% by weight of polyether blocks and from 95% to 15% by weight of polyamide blocks, preferably from 40% to 80% by weight of polyether blocks and from 60% to 20% by weight of polyamide blocks and more preferably from 45% to 75% by weight of polyether blocks and from 55% to 25% by weight of polyamide blocks.

Use may also be made, as a thermoplastic elastomer polymer, of a copolyether-block-urethane comprising a soft polyoxyalkylene block and a polyurethane block.

The polyurethane block can be obtained by reaction between a diisocyanate and a diol.

The polyether block can be as described above in connection with the PEBAs.

Use may also be made, as a thermoplastic elastomer polymer, of a copolyether-block-ester comprising a soft polyoxyalkylene block and a polyester block.

The polyester block can be obtained by polycondensation by esterification, of a carboxylic acid, such as isophthalic acid or terephthalic acid or a biobased carboxylic acid (such as furandicarboxylic acid), with a glycol, such as ethylene glycol, trimethylene glycol, propylene glycol or tetramethylene glycol.

The polyether block can be as described above in connection with the PEBAs.

According to the invention, the wood-polymer composite comprises less than 1% of coupling agent, preferably no coupling agent. Without wishing to be bound by the theory, the applicant believes that it is the functional groups of the thermoplastic elastomer polymer that interact with those of the wood fibers and which thus make it possible not to have to resort to a coupling agent during the preparation of the wood-polymer composite. As coupling agent, mention may be made of any compound that can interact both with the polymer matrix and the plant flour. Mention may be made of functionalized polyolefins such as polyethylene or polypropylene functionalized with maleic anhydride or acrylic acid.

The composite may be manufactured by a process comprising the following steps. Preferably, the plant flour and the thermoplastic elastomer polymer are subjected to a drying step. The plant flour is, for example, dried at a temperature between 80° C. and 130° C. for from 2 to 10 h. This period depends on the nature of the flour and its degree of moisture. The polymer is dried under vacuum at a temperature between 50° C. and 100° C. for around 5 hours.

Preferably, the plant flour and the polymer are dry blended directly in the mixing tool. The percentage of plant flour in the blend is in general less than or equal to 80% of the weight of the composite, preferably from 5% to 70%, preferably from 10% to 60%, more preferably from 10% to 55% of the weight of the composite.

The kneading (or compounding) is carried out using a twin-screw extruder in order to form granules of composite. The temperature of the nozzle of the extruder may be between 80° C. and 200° C.

The granules of composite are in general dried for several hours at a temperature between 50° C. and 120° C. before being injection molded or extruded through a die that has the shape of the desired article. The temperature and the duration of the drying depend on the type of flour, on the content of flour in the composite, on the nature of the polymer, on the duration and nature of the storage of the granules. The process according to the invention makes it possible to prepare granules or a profile, that is to say an object of predetermined precise shape.

The invention is not limited to the mixing of a single thermoplastic elastomer polymer with a single plant flour. It is also possible to envisage mixing several thermoplastic elastomers with several types of plant flour. The same is true for the compounding and shaping tools: these are those known to a person skilled in the art in the field of plastics processing.

### EXAMPLES

### a) Materials

The first type of flour WF1 is a spruce wood flour available from Rettenmaier under the reference C 120. The second type of flour WF2 is a maritime pine flour obtained by grinding and screening. Their characteristics are summarized in Table 1 below.

TABLE 1

| Characteristics | Lignocel C120 | Maritime pine wood |
|---|---|---|
| Species of wood | Spruce wood | Maritime pine |
| Particle size (μm) | 70-150 | 60-450 |
| Cellulose (%) | ~50 | ~42 |
| Lignin (%) | ~25 | ~28 |
| Hemicellulose (%) | ~25 | ~27 |

Two copolyether-block-amides PEBA 1 and PEBA 2 were manufactured in powder form by Arkema, at the Centre de Recherche, Développement, Applications et Technique de l'Ouest, Serquigny (27), France. They contain a polyamide block consisting of polyamide 11 (PA-11). The amount of PA-11 blocks is higher for PEBA 2 than for PEBA 1. PEBA 1 is representative of a “soft” copolyether-block-amide. PEBA 2 is representative of a “hard” copolyether-block-amide.

### b) Manufacture

b-1) Compounding

The wood flours were dried at 105° C. for 6 h. PEBA polymers were dried at 60° C. under vacuum for 5 hours. The polymers and the wood flours were then dry blended before compounding. Five filler levels (10, 20, 30, 40 and 50 wt %) were used in the preparation of the samples. The compounding was carried out using a laboratory twin-screw extruder (Thermo Scientific, Eurolab 16) in order to produce granules of composite. The extrusion temperature extends from 90° C. to 170° C.

b-2) Molding

The granules were dried for 16 h at 80° C. before injection molding of the samples intended for the tensile test (ISO 527-2). The composites were injection molded using a DK injection molding device operating under a pressure of 65 tons. The molding temperature is 15° C. and the temperature profile of the screw of the injection molding machine extends over a range of from 160° C. to 200° C. as a function of the percentage of wood fibers in the composite.

### c) Results:

The thermogravimetric analysis was carried out with a Perkin Elmer analyzer (TGA 4000). The PEBA 1 and 2 polymers, the wood flours and the composites were analyzed in order to determine their degradation temperatures and the time leading to their degradation. The dynamic analysis was carried out under nitrogen and in air at a heating rate of 10° C./min over a temperature range extending from 30° C. to 600° C. The isothermal test curves were plotted in air at a temperature of 220° C. for 720 minutes and 300° C. for 240 min, after heating at a rate of 10° C./min starting from 30° C. up to the test temperature.

c-1) Non-Isothermal Thermogravimetric Analysis:

### Thermal Stability Under Nitrogen

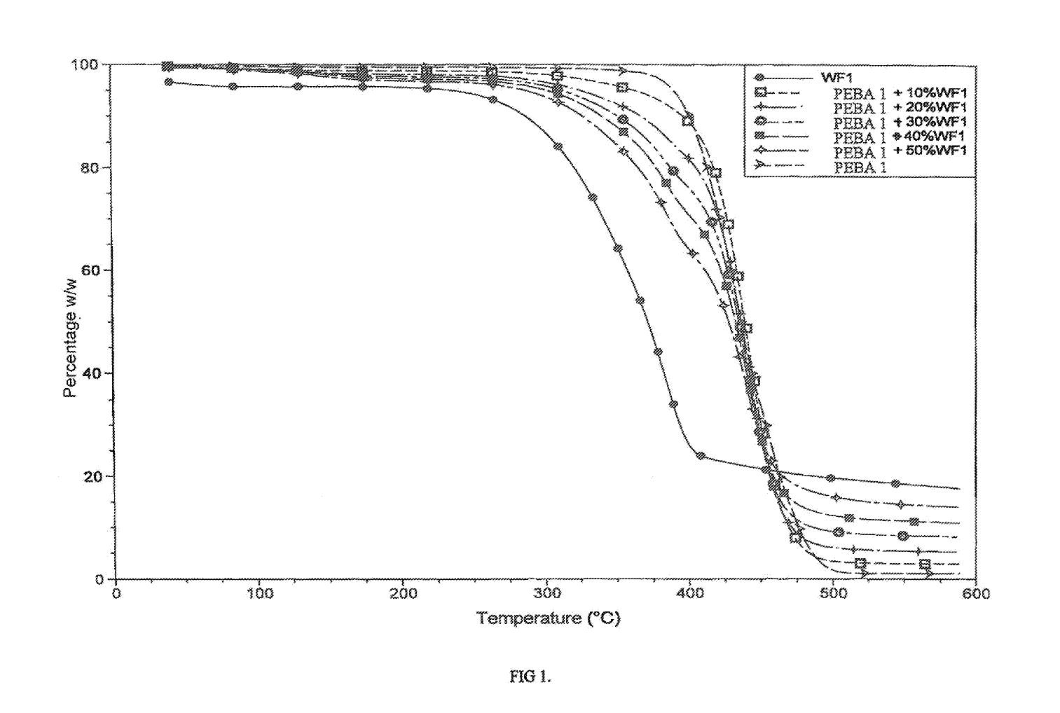

The thermal behavior of the PEBA 1 and 2 polymers, of the WF1 wood flour and of the PEBA/WF1 composites was studied by thermogravimetric analysis under nitrogen at a heating rate of 10° C./min in the temperature range extending from 30° C. to 600° C. FIG. 1 represents the reduction of the weight as a function of the temperature. The degradation of the sample occurs in a single step for the polymers and for the wood fibers. It is noted that the degradation curves of the composite lie between the degradation curve of the polymer alone and that of the flour alone. The decomposition temperature of the composite depends on its percentage of wood flour. It decreases when the percentage of wood flour increases. This result is consistent with the fact that a wood flour has a lower thermal degradation temperature than a PEBA polymer.

### Thermal Stability in Air

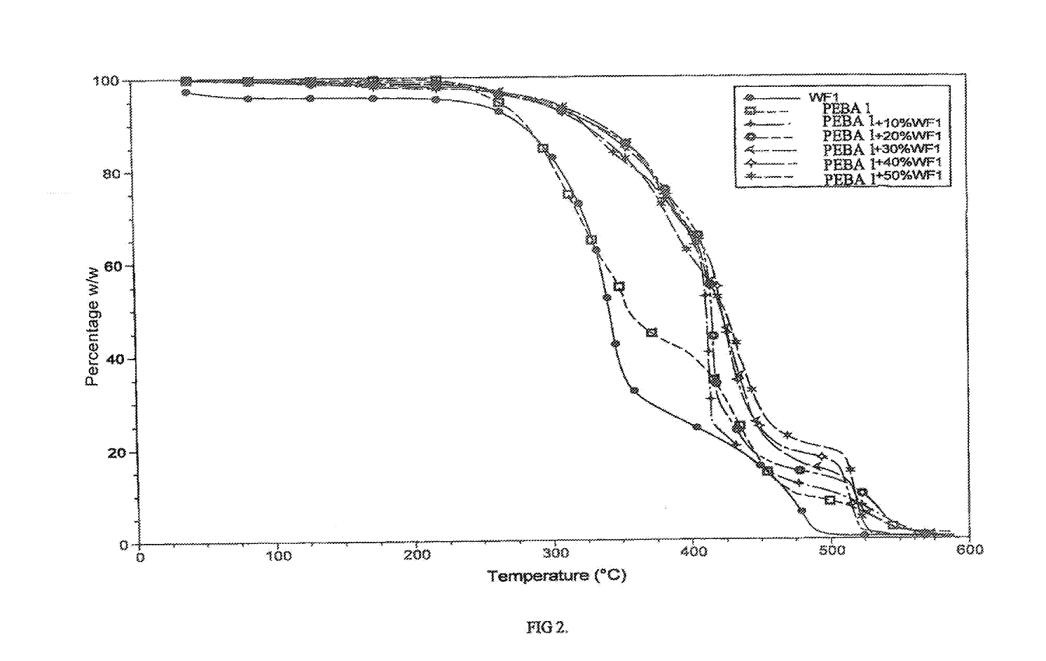

The thermal behavior of the PEBA polymers alone, of the WF1 wood flour and of the PEBA/WF1 composites was studied by thermogravimetric analysis in air at a heating rate of 10° C./min in the temperature range extending from 30° C. to 600° C. FIG. 2 represents the reduction in weight as a function of the temperature. The degradation of the samples occurs in several steps, for all the samples. A surprising result is observed: regardless of the percentage of wood flour in the composite, the PEBA/WF1 composites have a degradation temperature higher than that of the PEBA polymer alone and also that of the WF1 wood flour alone. This surprising result occurs when the sample is subjected to air whereas it does not occur when the sample is under a nitrogen atmosphere. This result demonstrates the synergistic effect that occurs between the polymer and the wood. The wood flour and the PEBA protect one another against thermal degradation.

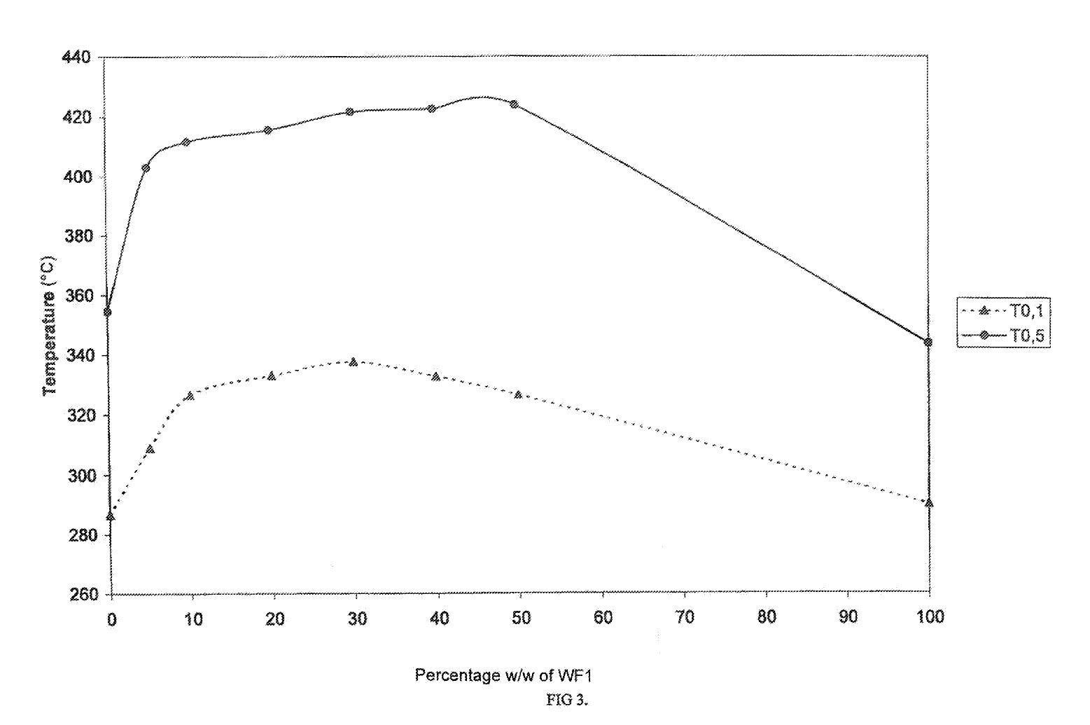

The temperatures corresponding to a reduction of 10% (T_{0.1}) and 50% (T_{0.5}) of the weight of the sample for various percentages of wood flour have been noted. FIG. 3 represents these temperatures T_{0.1} and T_{0.5} as a function of the percentage of wood flour in the composite. It is noted that T_{0.1} increases by 50° C. for a wood flour percentage of 30% with respect to PEBA alone and to the wood flour alone. It is even noted that T_{0.1} increases by 20° C. for a wood flour percentage of 5% with respect to the PEBA alone and the wood flour alone, which is significant. T_{0.5} increases by 50° C. to 70° C. when the content of wood flour increases from 5% to 50% with respect to the PEBA alone and the wood flour alone. The increase in the thermal degradation temperature is optimum for a wood flour percentage between 10% and 50%.

The applicant believes that the improvement in the thermal stability is due to the formation of a layer of a carbonization product at the start of the degradation phase which acts as a barrier and reduces the thermal oxidation process. This barrier effect may explain the reduction in the loss of mass, which is due to the slowing down of the diffusion of volatile products resulting from the thermal oxidation and of oxygen.

For degradation temperatures of 400° C. and 500° C., the percentage of undegraded composite (residue) W_{400° C.} and W_{500° C.} was noted for various wood flour percentages. It is observed in FIG. 3 that W_{400° C.} increases proportionally with the wood flour percentage for a wood flour percentage of less than 10%. Between 10% and 40% wood flour, W_{400° C.} varies little. Above 50% wood flour, it decreases. The parameter W_{500° C.} increases proportionally with the wood flour percentage for a wood flour percentage ranging up to 50%. It is greater than that of PEBA alone and wood flour alone.

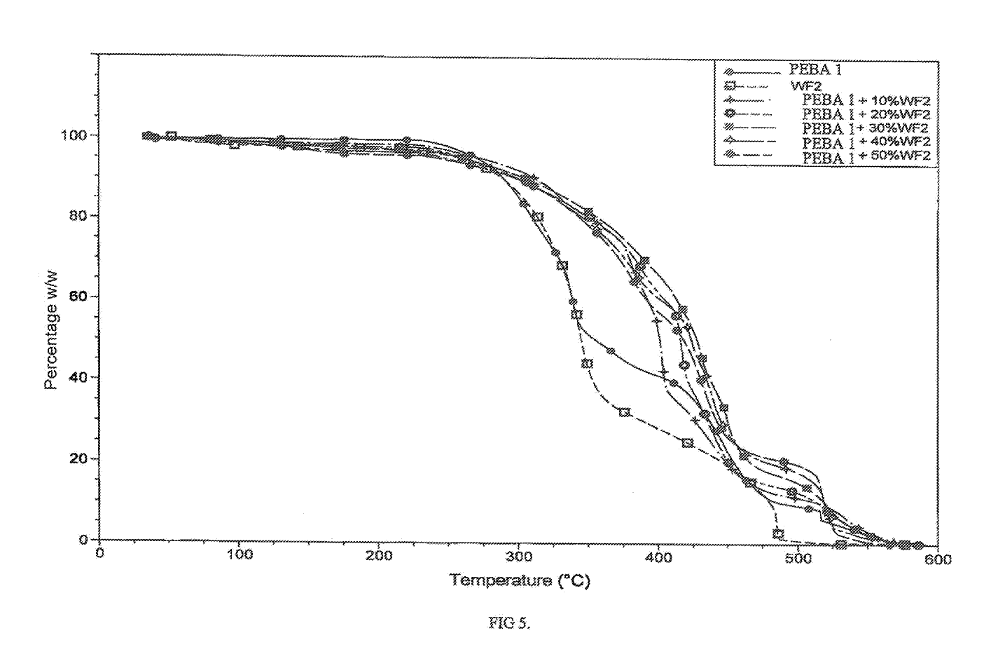

The thermal behavior of the PEBA 1 polymer alone, the WF2 wood flour alone and PEBA 1/WF2 composites was studied by thermogravimetric analysis in air at a heating rate of 10° C./min in the temperature range extending from 30° C. to 600° C. FIG. 5 represents the reduction in weight as a function of the temperature. The degradation of the samples occurs in several steps, for all the samples. As in the case of the PEBA/WF1 composite, it is noted that the PEBA/WF2 composites have a degradation temperature greater than that of the PEBA polymer alone and also than that of the WF2 wood flour alone.

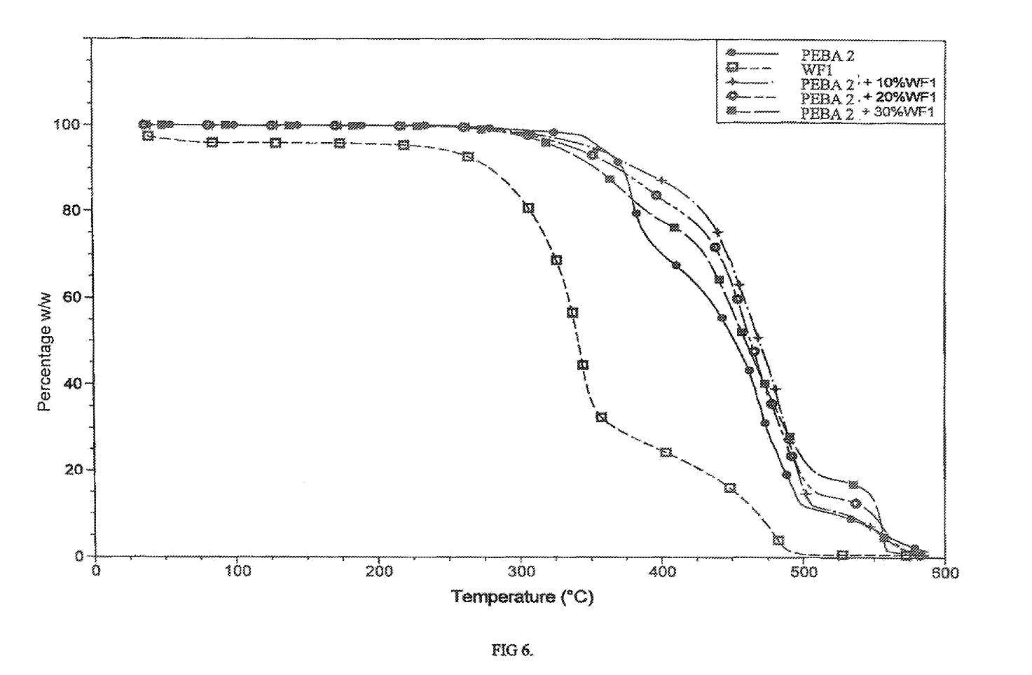

The thermal behavior of the PEBA 2 polymer alone, of the WF1 wood flour alone and of the PEBA 2/WF1 composites was studied by thermogravimetric analysis in air at a heating rate of 10° C./min in the temperature range extending from 30° C. to 600° C. FIG. 6 represents the reduction in weight as a function of the temperature. It is noted that the PEBA 2/WF1 composites have a degradation temperature greater than that of the PEBA 2 polymer alone and also than that of the WF1 wood flour alone. By comparing the results from FIG. 6 with those from FIG. 1, it is observed that the degradation of PEBA 2 starts at a higher temperature than for PEBA 1. This is explained by a higher polyamide/PTMG ratio in the case of PEBA 2.

PEBA 1 and 2 are copolymers comprising a hard polyamide block and a soft polyamide block. In order to understand the interactions between the wood flour and each block of the copolymer, tests of thermal degradation of the composites were carried out with a polymeric matrix corresponding to each of the blocks and wood flours.

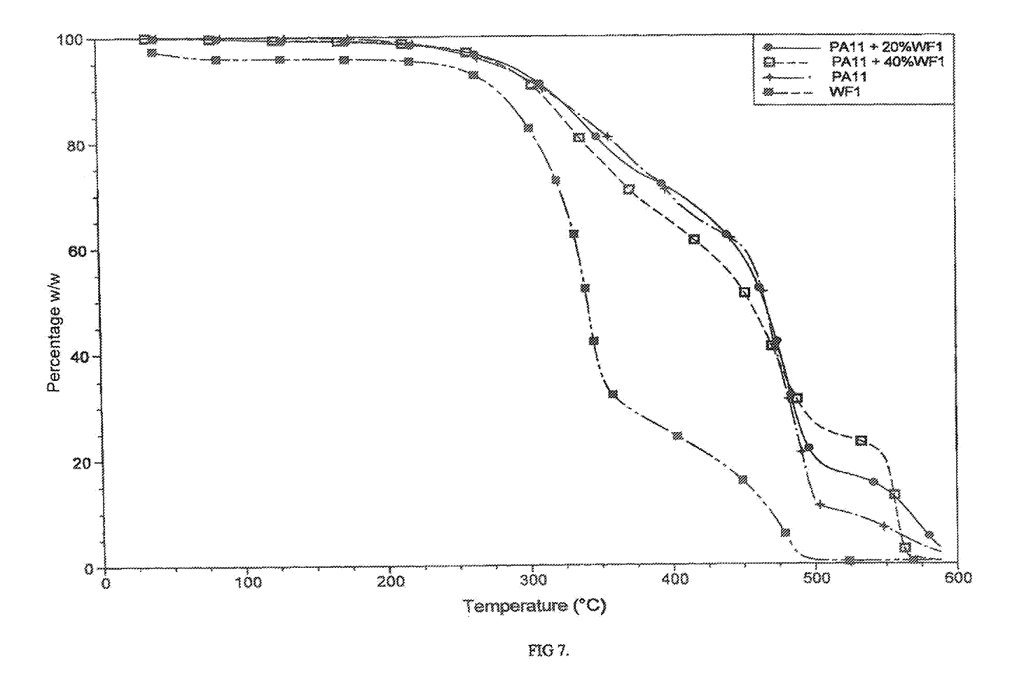

A composite comprising a homopolymer of polyamide 11 having a molecular weight Mn of 600 g/mol and WF1 wood flour was prepared. A thermogravimetric analysis of this compound was carried out. It is represented in FIG. 7. The degradation curves of the composite lie between the degradation curve of the polyamide 11 and that of the wood flour alone. The better thermal stability is obtained for the polyamide 11 alone. At a degradation temperature above 500° C., the amount of residue of composite is greater than that of the polyamide 11 alone and of the wood flour alone.

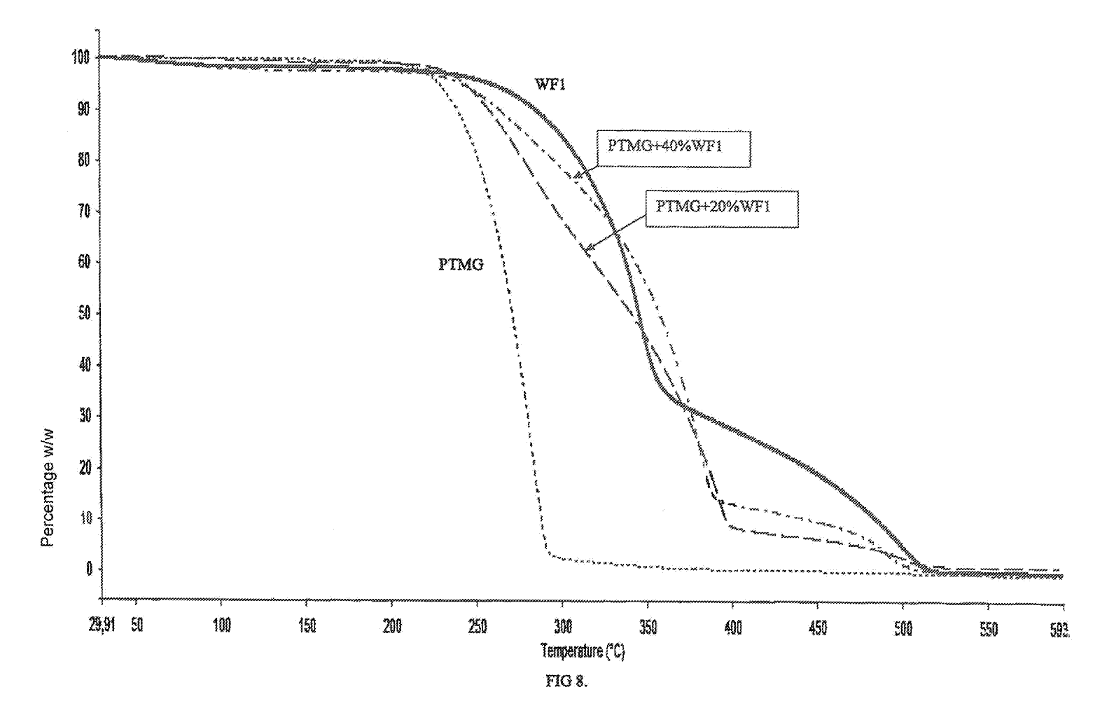

A composite comprising a homopolymer of polytetramethylene ether glycol (PTMG) having a molecular weight Mn of 2000 g/mol and WF1 wood flour was prepared. A thermogravimetric analysis of this compound was carried out. It is represented in FIG. 8. The degradation curves of the composite above 300° C. lie between the degradation curve of the PTMG and of the wood flour alone. The better thermal stability is obtained for the wood flour alone. The presence of the wood flour makes it possible to increase the degradation temperature of PTMG. Therefore, an effect of stabilization of the PTMG phase by the wood flour is observed due to the fact that the wood flour has a degradation temperature higher than that of the PTMG.

c-2) Non-Isothermal Thermogravimetric Analysis:

The objective of the thermogravimetric analysis is:

(i) to characterize the degradation behavior of the composites in air at constant temperature, and

(ii) to confirm the interactions between the wood fibers and the polymer already demonstrated by the dynamic thermogravimetric analysis.

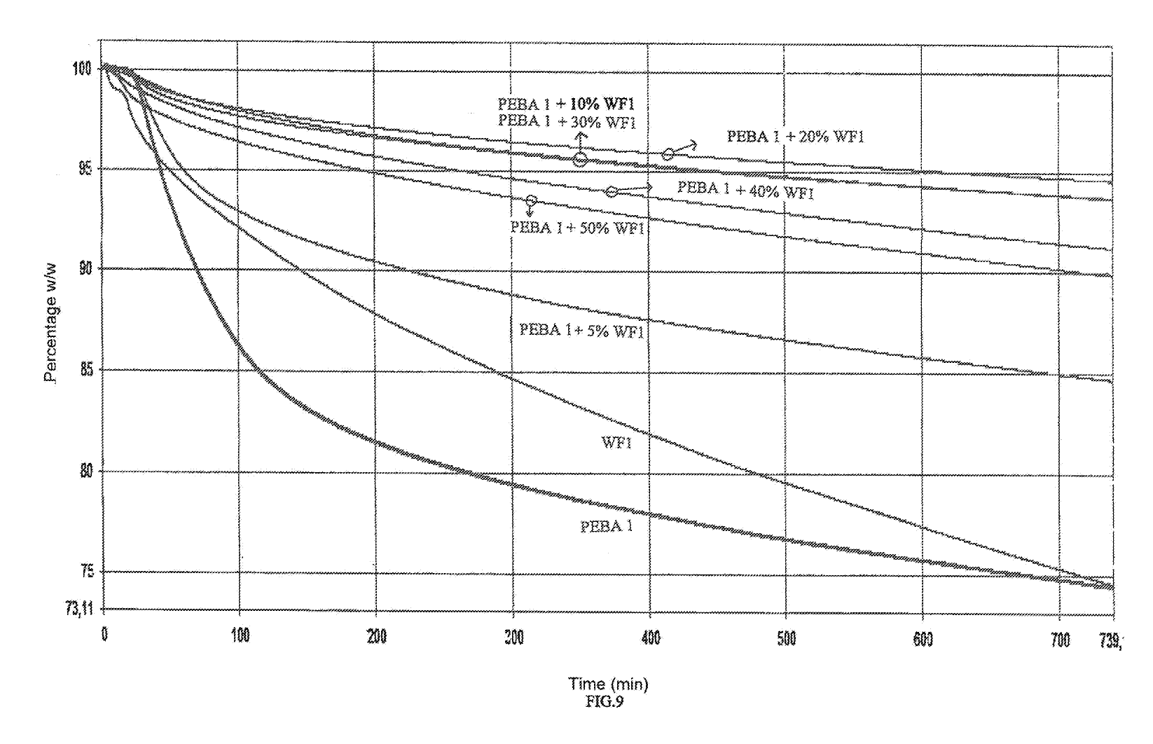

A first isothermal degradation test was carried out with PEBA 1 and WF1 in air at a temperature of 220° C. for 720 minutes, after heating from 30° C. at a rate of 10° C./min. The results are represented in FIG. 9. They show a synergistic effect between PEBA 1 and the WF1 wood fibers. Specifically, the weight loss of the PEBA/WF1 composite is less than that observed for the PEBA alone and the wood flour alone. This confirms the higher thermal stability of the composite with respect to that of the constituents taken separately.

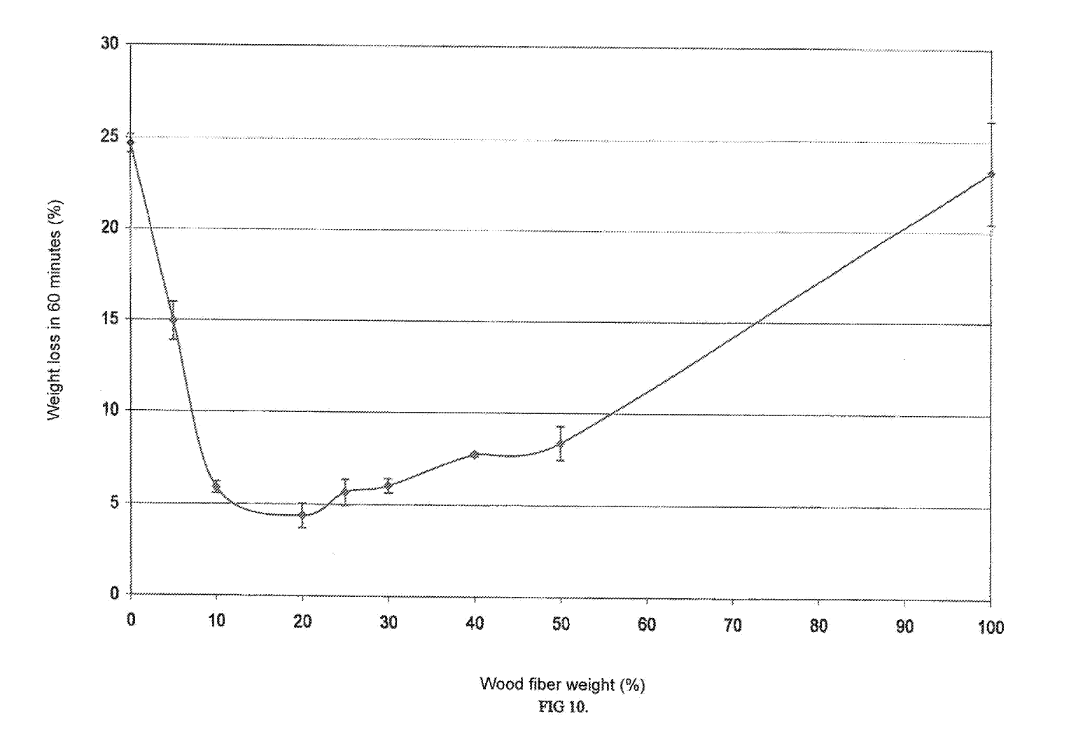

FIG. 10 represents the weight loss for an exposure of 600 minutes at 220° C. of composites comprising various wood flour percentages. It is noted that the minimum weight loss of the composite corresponds to around 20% by weight of wood flour. A significant protective effect is observed between the wood fibers and the PEBA, even for a low wood fiber percentage of 5%.

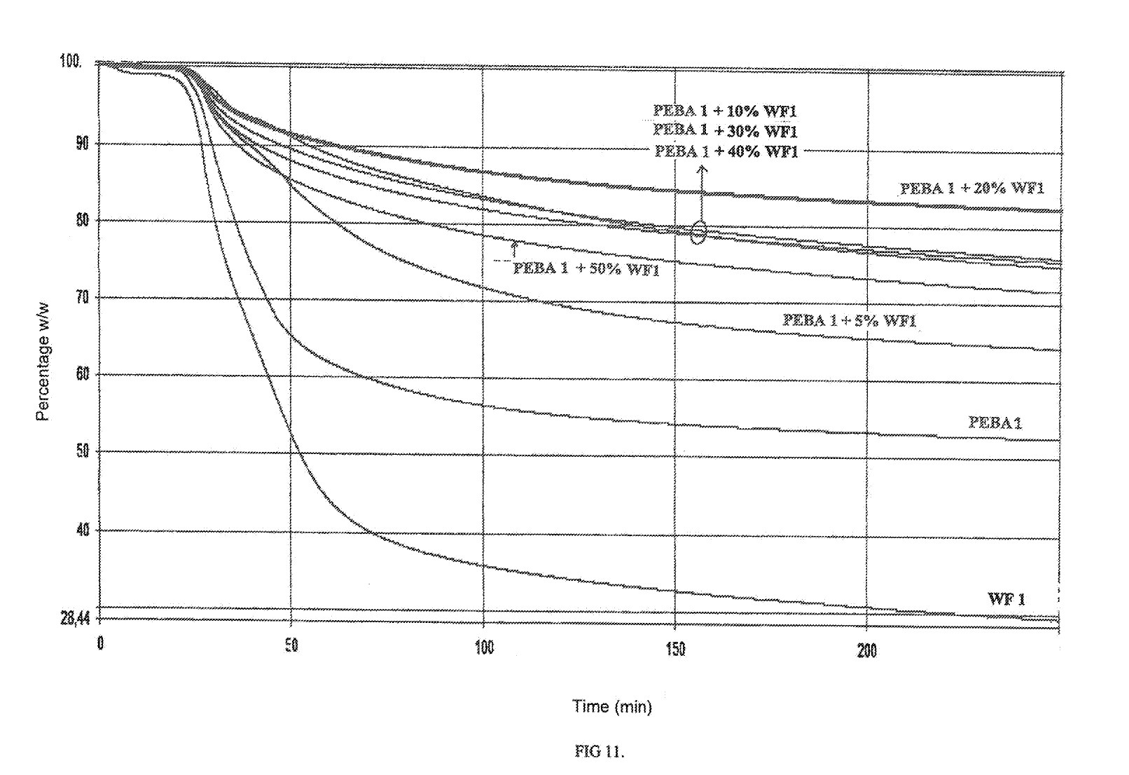

A second isothermal degradation test was carried out with PEBA 1 and WF1 in air at a temperature of 300° C. for 240 minutes, after heating from 30° C. at a rate of 10° C./min. The results are represented in FIG. 11. They show a synergistic effect between PEBA 1 and the WF1 wood fibers. Specifically, the weight loss of the PEBA/WF1 composite is less than that observed for the PEBA alone and the wood flour alone. This confirms the higher thermal stability of the composite with respect to that of the constituents taken separately.

The synergistic effect originates from the degradation of the wood in the presence of the polymer. Therefore, it depends on the percentage of wood. The most significant effect is obtained for a wood fiber percentage of 5% to 50%. The percentage of residue for 10% of fibers is close to that obtained with 40% of fibers. It reaches a minimum for a value of around 20% by weight of wood fibers.

1. A composite comprising:
a thermoplastic elastomer, wherein the thermoplastic elastomer is chosen from the group comprising copolyether-block-amides, copolyether-block-urethanes and copolyether-block-esters; and
a plant flour.

2. The composite as claimed in claim 1, wherein the plant flour originates from a plant chosen from the group comprising maritime pine, spruce wood, beech wood and corn cob.

3. (canceled)

4. The composite as claimed in claim 1, wherein the thermoplastic elastomer is a copolyether-block-amide comprising from 20% to 60% by weight of polyamide and from 40% to 80% by weight of polyether.

5. The composite as claimed in claim 1, wherein the copolyether-block amide comprises a soft polytetramethylene ether glycol block.

6. The composite as claimed in claim 1, wherein the polyamide is polyamide 11.

7. The composite as claimed in claim 1, wherein the plant flour represents less than 10% of the weight of the composite.

8. The composite as claimed in claim 1, wherein the plant flour represents from 10% to 80% of the weight of the composite.

9. The composite as claimed in claim 1, containing less than 5% of coupling agent.

10. A granule comprising a composite as claimed in claim 1.

11. A construction material comprising a composite as claimed in claim 1.

12. A shoe comprising a composite as claimed in claim 1.

13. A piece of furniture comprising a composite as claimed in claim 1.

14. A passenger compartment comprising a composite as claimed in claim 1.

15. A process for manufacturing a composite as claimed in claim 1, comprising the steps of:
a) introducing the thermoplastic elastomer and the plant flour into an extruder,
b) extruding the mixture in the form of granules or profile.

16. The process as claimed in claim 15, comprising, before step a), a step of preparing a mixture of the thermoplastic elastomer with the plant flour.

17. The process as claimed in claim 15, comprising, before step a), a step of drying the thermoplastic elastomer and the plant flour.

18. The process as claimed in claim 15, comprising, after step b), a step of drying the composite followed by a step of compression in order to form a granule or a profile.

19. The composite as claimed in claim 1, wherein the thermoplastic elastomer is chosen from the group of copolyether-block-amides.

20. The composition as claimed in claim 4, wherein said copolyether-block-amide comprises from 25% to 55% by weight of polyamide and 45% to 75% by weight of polyether.

21. The composition as claimed in claim 8, wherein the said plant flour represents from 20% to 50% of the weight of the composite.

22. The composite as claimed in claim 8, wherein said plant flour represents from 20% to 40% of the weight of the composite.

23. The composite as claimed in claim 9, wherein it contains less than 1% of coupling agent.
